(19) United States
(12) Patent Application Publication
(10) Pub. No.: US 2026/0333508 A1
(43) Pub. Date: Oct. 22, 2026

(54) DEVICE AND METHOD FOR CONFIGURING PARAMETERS RELATED TO DISCONTINUOUS RECEPTION OPERATION IN WIRELESS COMMUNICATION SYSTEM

(71) Applicant: LG ELECTRONICS INC., Seoul (KR)

(72) Inventors: Yecheng HE, Seoul (KR); Jihwan JANG, Seoul (KR); Jaeky OH, Seoul (KR); Jaehoon CHUNG, Seoul (KR)

(73) Assignee: LG ELECTRONICS INC., Seoul (KR)

(21) Appl. No.: 19/105,693

(22) PCT Filed: Aug. 29, 2022
(86) PCT No.: PCT/KR2022/012893

§ 371 Date: Feb. 21, 2025

(51) Int. Cl. H04W 76/28; H04L 41/16

(52) U.S. Cl. CPC H04W 76/28; H04L 41/16

(57) ABSTRACT

The present disclosure relates to configuring parameters related to a DRX operation in a wireless communication system, and a method for operating a user equipment (UE) may include receiving configuration information related to a discontinuous reception (DRX) operation from a base station, performing the DRX operation based on the configuration information, transmitting a first message including information related to at least one parameter related to the DRX operation, and receiving a second message including information related to reconfiguration for the at least one parameter. The first message may include information related to a traffic feature that is determined by the UE and is used to reconfigure the at least one parameter.

### CROSS-REFERENCE TO RELATED APPLICATION(S)

This application is the National Stage filing under 35 U.S.C. 371 of International Application No. PCT/KR2022/012893, filed on Aug. 29, 2022, the contents of which is hereby incorporated by reference herein in its entirety.

### TECHNICAL FIELD

The present disclosure relates to a wireless communication system, and more particularly, to an apparatus and method for configuring parameters related to a discontinuous reception (DRX) operation in a wireless communication system.

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (MTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

The present disclosure may provide an apparatus and method for effectively configuring parameters related to a discontinuous reception (DRX) operation in a wireless communication system.

The present disclosure may provide an apparatus and method for configuring at least one parameter related to a DRX operation based on a traffic feature of a terminal in a wireless communication system.

The present disclosure may provide an apparatus and method for configuring at least one parameter related to a DRX operation based on an artificial intelligence (AI) model in a wireless communication system.

The present disclosure may provide an apparatus and method for configuring at least one parameter related to a DRX operation by using Tompson sampling technique in a wireless communication system.

The present disclosure may provide an apparatus and method for configuring at least one parameter related to a DRX operation according to terminal-initiated approach in a wireless communication system.

The present disclosure may provide an apparatus and method for transmitting at least one parameter related to a DRX operation determined by a terminal to a base station in a wireless communication system.

The present disclosure may provide an apparatus and method for transmitting at least one parameter related to a DRX operation determined by a terminal to a base station in a wireless communication system.

The technical objects to be achieved in the present disclosure are not limited to the above-mentioned technical objects, and other technical objects that are not mentioned may be considered by those skilled in the art through the embodiments described below.

As an example of the present disclosure, a method for operating a user equipment (UE) in a wireless communication system may include receiving configuration information related to a discontinuous reception (DRX) operation from a base station, performing the DRX operation based on the configuration information, transmitting a first message including information related to at least one parameter related to the DRX operation, and receiving a second message including information related to reconfiguration for the at least one parameter. The first message may include information related to a traffic feature that is determined by the UE and is used to reconfigure the at least one parameter.

As an example of the present disclosure, a method for operating a base station in a wireless communication system may include transmitting configuration information related to a discontinuous reception (DRX) operation to a user equipment (UE), controlling the DRX operation based on the configuration information, receiving a first message including information related to at least one parameter related to the DRX operation, and transmitting a second message including information related to reconfiguration for the at least one parameter. The first message may include information related to a traffic feature that is determined by the UE and is used to reconfigure the at least one parameter.

As an example of the present disclosure, a user equipment (UE) in a wireless communication system may include a transceiver and a processor coupled with the transceiver. The processor may be configured to receive configuration information related to a discontinuous reception (DRX) operation from a base station, to perform the DRX operation based on the configuration information, to transmit a first message including information related to at least one parameter related to the DRX operation, and to receive a second message including information related to reconfiguration for the at least one parameter. The first message may include information related to a traffic feature that is determined by the UE and is used to reconfigure the at least one parameter.

As an example of the present disclosure, a base station in a wireless communication system may include a transceiver and a processor coupled with the transceiver. The processor may be configured to transmit configuration information related to a discontinuous reception (DRX) operation to a user equipment (UE), to control the DRX operation based on the configuration information, to receive a first message including information related to at least one parameter related to the DRX operation, and to transmit a second message including information related to reconfiguration for the at least one parameter. The first message may include information related to a traffic feature that is determined by the UE and is used to reconfigure the at least one parameter.

As an example of the present disclosure, a device may include at least one processor and at least one computer memory coupled with the at least one processor and storing an instruction that instructs operations when executed by the at least one processor. The operations may include, by the device, receiving configuration information related to a discontinuous reception (DRX) operation from a base station, performing the DRX operation based on the configuration information, transmitting a first message including information related to at least one parameter related to the DRX operation, and receiving a second message including information related to reconfiguration for the at least one parameter. The first message may include information related to a traffic feature that is determined by the UE and is used to reconfigure the at least one parameter.

As an example of the present disclosure, a non-transitory computer-readable medium storing at least one instruction may include the at least one instruction that is executable by a processor. The at least one instruction may control a device to receive configuration information related to a discontinuous reception (DRX) operation from a base station, to perform the DRX operation based on the configuration information, to transmit a first message including information related to at least one parameter related to the DRX operation, and to receive a second message including information related to reconfiguration for the at least one parameter. The first message may include information related to a traffic feature that is determined by the UE and is used to reconfigure the at least one parameter.

The above-described aspects of the present disclosure are merely some of the preferred embodiments of the present disclosure, and various embodiments reflecting the technical features of the present disclosure may be derived and understood by those of ordinary skill in the art based on the following detailed description of the disclosure.

As is apparent from the above description, the embodiments of the present disclosure have the following effects.

According to the present disclosure, parameters related to a discontinuous reception (DRX) operation can be effectively configured.

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates an example of a communication system applicable to the present disclosure.

FIG. 2 illustrates an example of a wireless apparatus applicable to the present disclosure.

FIG. 3 illustrates another example of a wireless device applicable to the present disclosure.

FIG. 4 illustrates an example of a hand-held device applicable to the present disclosure.

FIG. 5 illustrates an example of a car or an autonomous driving car applicable to the present disclosure.

FIG. 6 illustrates an example of an AI (Artificial Intelligence) device applied to the present disclosure.

FIG. 7 illustrates a method of processing a transmitted signal applied to the present disclosure.

FIG. 8 illustrates an example of a communication structure providable in a 6G (6th generation) system applicable to the present disclosure.

FIG. 9 illustrates an electromagnetic spectrum applicable to the present disclosure.

FIG. 10 illustrates a THz communication method applicable to the present disclosure.

FIG. 11 illustrates examples of probability density function of beta distribution applicable to the present disclosure.

FIG. 12A to FIG. 12D illustrate an example of update of a probability distribution model applicable to the present disclosure.

FIG. 13 illustrates an example of a cycle of a discontinuous reception (DRX) operation in a wireless communication system according to an embodiment of the present disclosure.

FIG. 14 illustrates an example of a situation in which data is received during a DRX operation in a wireless communication system according to an embodiment of the present disclosure.

FIG. 15A to FIG. 15C illustrate examples of power consumption distributions according to each situation in a wireless communication system according to an embodiment of the present disclosure.

FIG. 16 illustrates a concept of control of parameters related to a DRX operation in a wireless communication system according to an embodiment of the present disclosure.

FIG. 17 illustrates an example of an artificial intelligence (AI) model for predicting a traffic feature in a wireless communication system according to an embodiment of the present disclosure.

FIG. 18 illustrates a concept of parameter determination based on Thompson sampling (TS) in a wireless communication system according to an embodiment of the present disclosure.

FIG. 19 illustrates examples of probability density function of beta distribution available in a wireless communication system according to an embodiment of the present disclosure.

FIG. 20 illustrates an example of a procedure of performing a DRX operation in a wireless communication system according to an embodiment of the present disclosure.

FIG. 21 illustrates an example of a procedure of controlling a DRX operation in a wireless communication system according to an embodiment of the present disclosure.

FIG. 22 illustrates an example of a procedure of determining a parameter related to a DRX operation in a wireless communication system according to an embodiment of the present disclosure.

FIG. 23 illustrates examples of DRX operation according to a traffic feature in a wireless communication system according to an embodiment of the present disclosure.

FIG. 24 illustrates an example of signal exchange for updating a parameter related to a DRX operation in a wireless communication system according to an embodiment of the present disclosure.

FIG. 25 illustrates an example of a procedure for updating a parameter related to a DRX operation in a wireless communication system according to an embodiment of the present disclosure.

FIG. 26 illustrates a reward structure based on TS in a wireless communication system according to an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

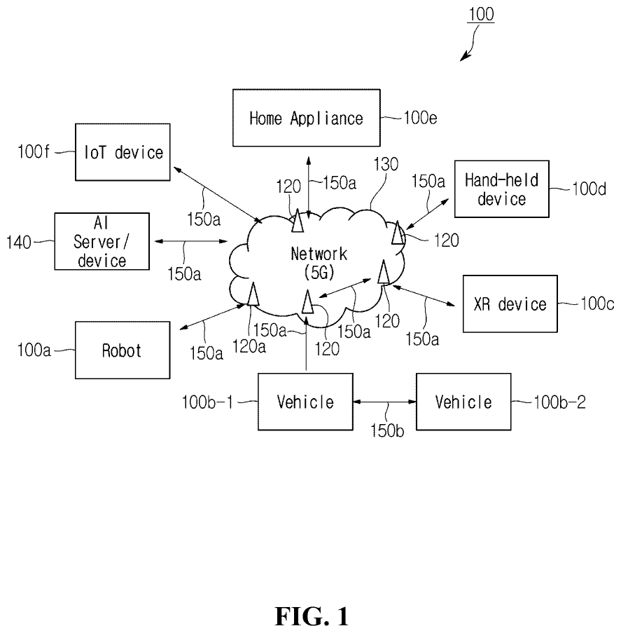

FIG. 1 illustrates an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

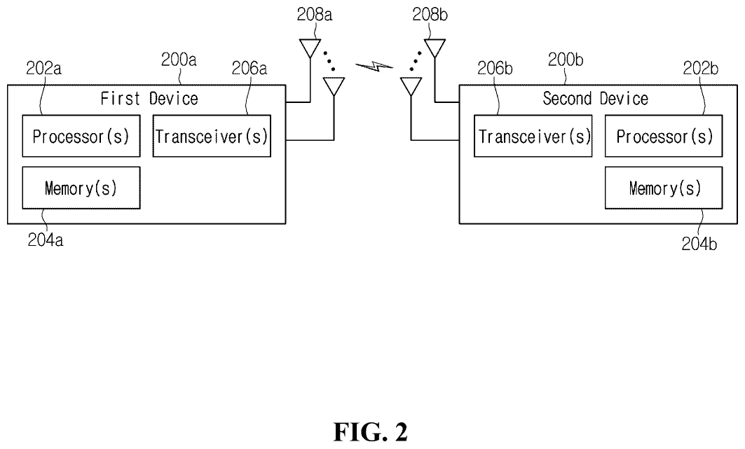

FIG. 2 illustrates an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

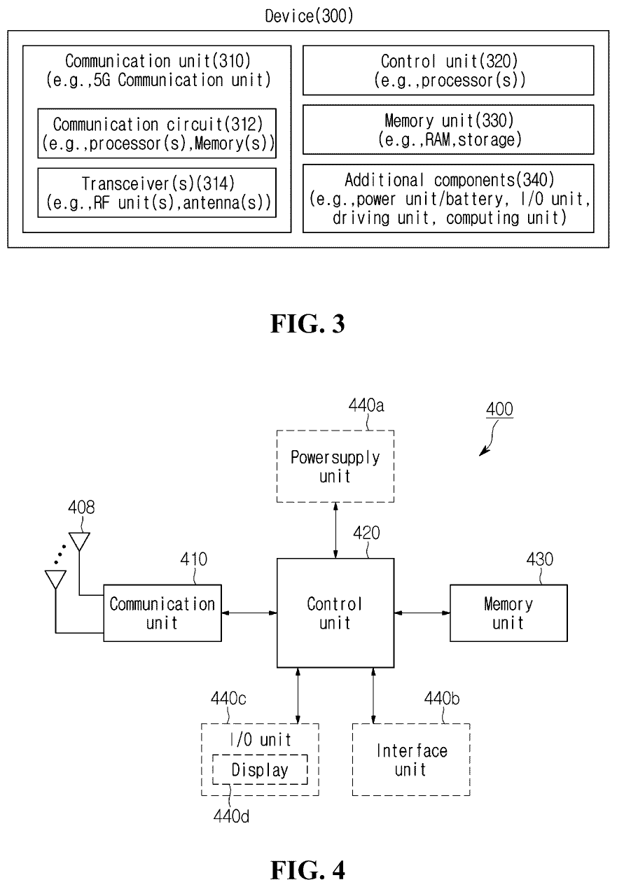

FIG. 3 illustrates another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

FIG. 4 illustrates an example of an AI device applied to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

### Type of Wireless Device Applicable to the Present Disclosure

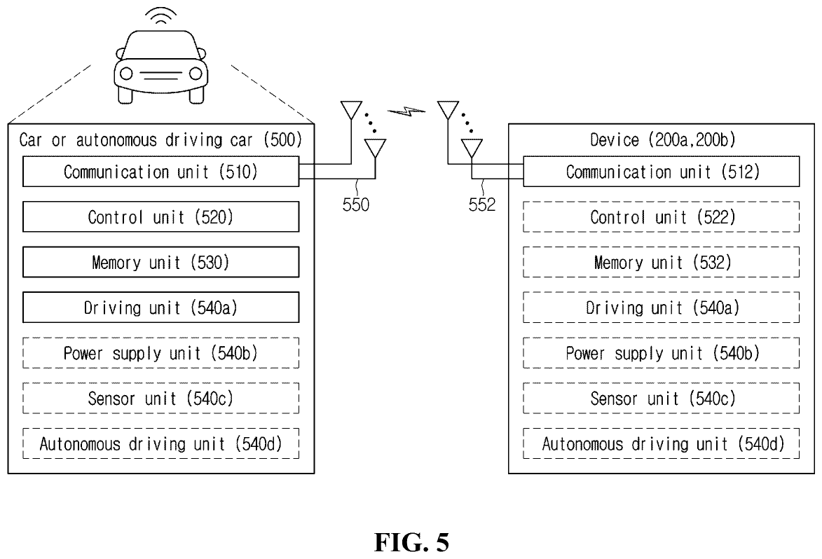

FIG. 5 illustrates an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

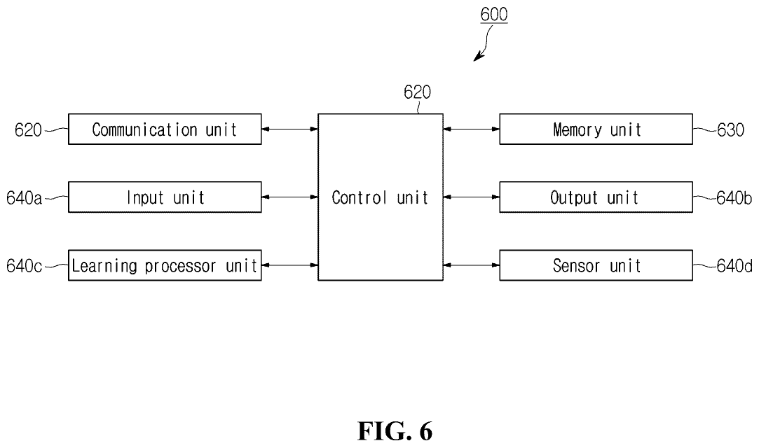

FIG. 6 illustrates an example of an AI device applied to the present disclosure. For example, the AI device may be implemented as a fixed device or a movable device such as TV, projector, smartphone, PC, laptop, digital broadcasting terminal, tablet PC, wearable device, set-top box (STB), radio, washing machine, refrigerator, digital signage, robot, vehicle, etc.

Referring to FIG. 6, the AI device 600 may include a communication unit 610, a control unit 620, a memory unit 630, an input/output unit 640a/640b, a learning processor unit 640c and a sensor unit 640d. Blocks 610 to 630/640A to 640D may correspond to blocks 310 to 330/340 of FIG. 3, respectively.

The communication unit 610 may transmit and receive a wired and wireless signal (e.g., sensor information, user input, learning model, control signal, etc.) to and from external devices such as another AI device (e.g., 100x, 120, 140 in FIG. 1) or an AI server (140 in FIG. 1) using wired/wireless communication technology. To this end, the communication unit 610 may transmit information in the memory unit 630 to an external device or send a signal received from an external device to the memory unit 630.

The control unit 620 may determine at least one executable operation of the AI device 600 based on information determined or generated using a data analysis algorithm or machine learning algorithm. In addition, the control unit 620 may control the components of the AI device 600 to perform the determined operation. For example, the control unit 620 may request, search, receive, or utilize the data of the learning processor 640c or the memory unit 630, and control the components of the AI device 600 to perform predicted operation or operation determined to be preferred among at least one executable operation. In addition, the control unit 620 collects history information including a user's feedback on the operation content or operation of the AI device 600, and stores it in the memory unit 630 or the learning processor 640c or transmit it to an external device such as the AI server (140 in FIG. 1). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensor unit 640. Also, the memory unit 630 may store control information and/or software code required for operation/execution of the control unit 620.

The input unit 640a may obtain various types of data from the outside of the AI device 600. For example, the input unit 620 may obtain learning data for model learning, input data to which the learning model is applied, etc. The input unit 640a may include a camera, a microphone and/or a user input unit, etc. The output unit 640b may generate audio, video or tactile output. The output unit 640b may include a display unit, a speaker and/or a haptic module. The sensor unit 640 may obtain at least one of internal information of the AI device 600, surrounding environment information of the AI device 600 or user information using various sensors. The sensor unit 640 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, and/or a radar.

The learning processor unit 640c may train a model composed of an artificial neural network using learning data. The learning processor unit 640c may perform AI processing together with the learning processor unit of the AI server (140 in FIG. 1). The learning processor unit 640c may process information received from an external device through the communication unit 610 and/or information stored in the memory unit 630. In addition, the output value of the learning processor unit 640c may be transmitted to an external device through the communication unit 610 and/or stored in the memory unit 630.

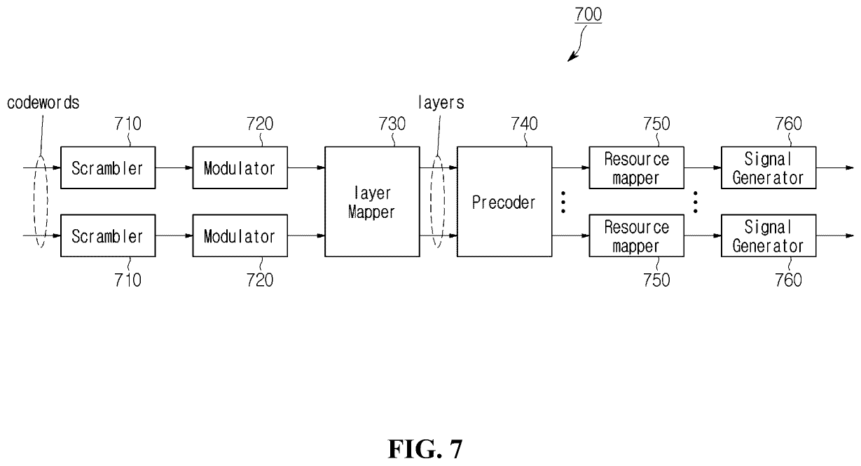

FIG. 7 illustrates a method of processing a transmitted signal applied to the present disclosure. For example, the transmitted signal may be processed by a signal processing circuit. In this case, the signal processing circuit 700 may include a scrambler 710, a modulator 720, a layer mapper 730, a precoder 740, a resource mapper 750, and a signal generator 760. At this time, as an example, the operation/function of FIG. 7 may be performed by the processors 202a and 202b and/or the transceivers 206a and 206b of FIG. 2. Also, as an example, the hardware elements of FIG. 7 may be implemented in the processors 202a and 202b and/or the transceivers 206a and 206b of FIG. 2. As an example, blocks 710 to 760 may be implemented in the processors 202a and 202b of FIG. 2. Also, blocks 710 to 750 may be implemented in the processors 202a and 202b of FIG. 2, and block 760 may be implemented in the transceivers 206a and 206b of FIG. 2, and are not limited to the above-described embodiment.

A codeword may be converted into a radio signal through the signal processing circuit 700 of FIG. 7. Here, the codeword is an encoded bit sequence of an information block. Information blocks may include transport blocks (e.g., UL-SCH transport blocks, DL-SCH transport blocks). The radio signal may be transmitted through various physical channels (e.g., PUSCH, PDSCH). Specifically, the codeword may be converted into a scrambled bit sequence by the scrambler 710. A scramble sequence used for scrambling is generated based on an initialization value, and the initialization value may include ID information of a wireless device. The scrambled bit sequence may be modulated into a modulation symbol sequence by the modulator 720. The modulation method may include pi/2-binary phase shift keying (pi/2-BPSK), m-phase shift keying (m-PSK), m-quadrature amplitude modulation (m-QAM), and the like.

A complex modulation symbol sequence may be mapped to one or more transport layers by the layer mapper 730. Modulation symbols of each transport layer may be mapped to corresponding antenna port(s) by the precoder 740 (precoding). The output z of the precoder 740 may be obtained by multiplying the output y of the layer mapper 730 by a N*M precoding matrix W. Here, N is the number of antenna ports and M is the number of transport layers. Here, the precoder 740 may perform precoding after transform precoding (e.g., discrete Fourier transform (DFT)) on complex modulation symbols. Also, the precoder 740 may perform precoding without performing transform precoding.

The resource mapper 750 may map modulation symbols of each antenna port to time-frequency resources. The time-frequency resources may include a plurality of symbols (e.g., CP-OFDMA symbols and DFT-s-OFDMA symbols) in the time domain and may include a plurality of subcarriers in the frequency domain. The signal generator 760 generates a radio signal from the mapped modulation symbols, and the generated radio signal may be transmitted to other devices through each antenna. To this end, the signal generator 760 may include an inverse fast Fourier transform (IFFT) module, a cyclic prefix (CP) inserter, a digital-to-analog converter (DAC), a frequency uplink converter, and the like.

A signal processing process for a received signal in a wireless device may be configured as the reverse of the signal processing processes 710 to 760 of FIG. 7. For example, a wireless device (e.g., 200a and 200b of FIG. 2) may receive a radio signal from the outside through an antenna port/transceiver. The received radio signal may be converted into a baseband signal through a signal reconstructor. To this end, the signal reconstructor may include a frequency downlink converter, an analog-to-digital converter (ADC), a CP remover, and a fast Fourier transform (FFT) module. Thereafter, the baseband signal may be reconstructed to a codeword through a resource de-mapper process, a postcoding process, a demodulation process, and a de-scramble process. The codeword may be reconstructed to an original information block through decoding. Accordingly, a signal processing circuit (not shown) for a received signal may include a signal reconstructor, a resource de-mapper, a postcoder, a demodulator, a de-scrambler, and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 1 shows the requirements of the 6G system.

TABLE 1

| | |
|---|---|
| Per device peak data rate | 1 Tbps |
| E2E latency | 1 ms |
| Maximum spectral efficiency | 100 bps/Hz |
| Mobility support | up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

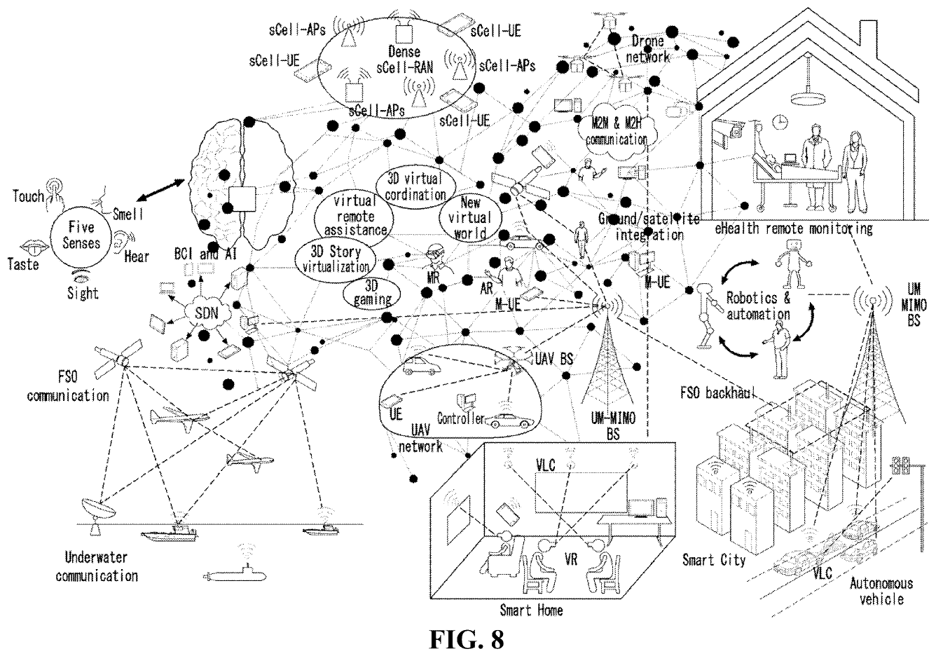

FIG. 8 illustrates an example of a communication structure providable in a 6G system applicable to the present disclosure.

Referring to FIG. 8, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System

### Artificial Intelligence (AI)

The most important and newly introduced technology for the 6G system is AI. AI was not involved in the 4G system. 5G systems will support partial or very limited AI. However, the 6G system will support AI for full automation. Advances in machine learning will create more intelligent networks for real-time communication in 6G. Introducing AI in communication may simplify and enhance real-time data transmission. AI may use a number of analytics to determine how complex target tasks are performed. In other words, AI may increase efficiency and reduce processing delay.

Time consuming tasks such as handover, network selection, and resource scheduling may be performed instantly by using AI. AI may also play an important role in machine-to-machine, machine-to-human and human-to-machine communication. In addition, AI may be a rapid communication in a brain computer interface (BCI). AI-based communication systems may be supported by metamaterials, intelligent structures, intelligent networks, intelligent devices, intelligent cognitive radios, self-sustained wireless networks, and machine learning.

Recently, attempts have been made to integrate AI with wireless communication systems, but application layers, network layers, and in particular, deep learning have been focused on the field of wireless resource management and allocation. However, such research is gradually developing into the MAC layer and the physical layer, and in particular, attempts to combine deep learning with wireless transmission are appearing in the physical layer. AI-based physical layer transmission means applying a signal processing and communication mechanism based on an AI driver rather than a traditional communication framework in fundamental signal processing and communication mechanisms. For example, deep learning-based channel coding and decoding, deep learning-based signal estimation and detection, deep learning-based multiple input multiple output (MIMO) mechanism, and AI-based resource scheduling and allocation may be included.

Machine learning may be used for channel estimation and channel tracking, and may be used for power allocation, interference cancellation, and the like in a downlink (DL) physical layer. Machine learning may also be used for antenna selection, power control, symbol detection, and the like in a MIMO system.

However, the application of DNN for transmission in the physical layer may have the following problems.

Deep learning-based AI algorithms require a lot of training data to optimize training parameters. However, due to limitations in obtaining data in a specific channel environment as training data, a lot of training data is used offline. This is because static training on training data in a specific channel environment may cause a contradiction between diversity and dynamic characteristics of a radio channel.

In addition, current deep learning mainly targets real signals. However, the signals of the physical layer of wireless communication are complex signals. In order to match the characteristics of a wireless communication signal, additional research on a neural network that detects a complex domain signal is required.

Hereinafter, machine learning will be described in greater detail.

Machine learning refers to a series of operations for training a machine to create a machine capable of performing a task which can be performed or is difficult to be performed by a person. Machine learning requires data and a learning model. In machine learning, data learning methods may be largely classified into three types: supervised learning, unsupervised learning, and reinforcement learning.

Neural network learning is to minimize errors in output. Neural network learning is a process of updating the weight of each node in the neural network by repeatedly inputting learning data to a neural network, calculating the output of the neural network for the learning data and the error of the target, and backpropagating the error of the neural network from the output layer of the neural network to the input layer in a direction to reduce the error.

Supervised learning uses learning data labeled with correct answers in the learning data, and unsupervised learning may not have correct answers labeled with the learning data. That is, for example, learning data in the case of supervised learning related to data classification may be data in which each learning data is labeled with a category. Labeled learning data is input to the neural network, and an error may be calculated by comparing the output (category) of the neural network and the label of the learning data. The calculated error is backpropagated in a reverse direction (i.e., from the output layer to the input layer) in the neural network, and the connection weight of each node of each layer of the neural network may be updated according to backpropagation. The amount of change in the connection weight of each updated node may be determined according to a learning rate. The neural network's computation of input data and backpropagation of errors may constitute a learning cycle (epoch). The learning rate may be applied differently according to the number of iterations of the learning cycle of the neural network. For example, in the early stages of neural network learning, a high learning rate is used to allow the neural network to quickly achieve a certain level of performance to increase efficiency, and in the late stage of learning, a low learning rate may be used to increase accuracy.

A learning method may vary according to characteristics of data. For example, when the purpose is to accurately predict data transmitted from a transmitter in a communication system by a receiver, it is preferable to perform learning using supervised learning rather than unsupervised learning or reinforcement learning.

The learning model corresponds to the human brain, and although the most basic linear model may be considered, a paradigm of machine learning that uses a neural network structure with high complexity such as artificial neural networks as a learning model is referred to as deep learning.

The neural network cord used in the learning method is largely classified into deep neural networks (DNN), convolutional deep neural networks (CNN), and recurrent Boltzmann machine (RNN), and this learning model may be applied.

### Terahertz (THz) Communication

THz communication is applicable to the 6G system. For example, a data rate may increase by increasing bandwidth. This may be performed by using sub-TH communication with wide bandwidth and applying advanced massive MIMO technology.

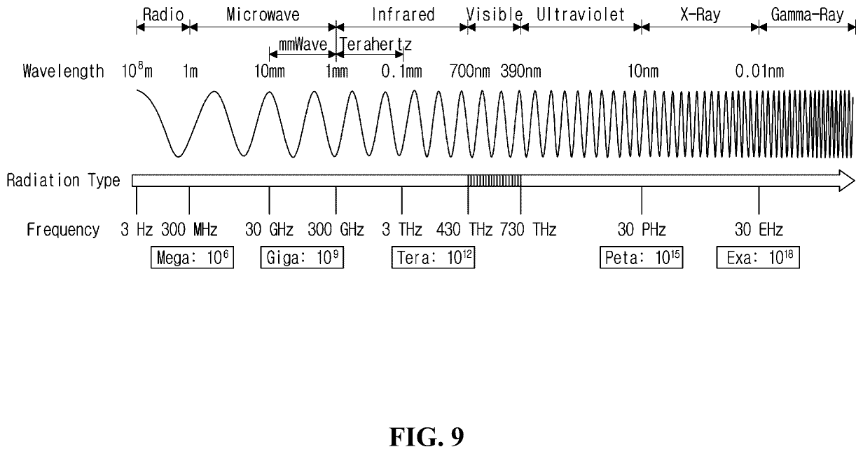

FIG. 9 illustrates an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated in the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### THz Wireless Communication

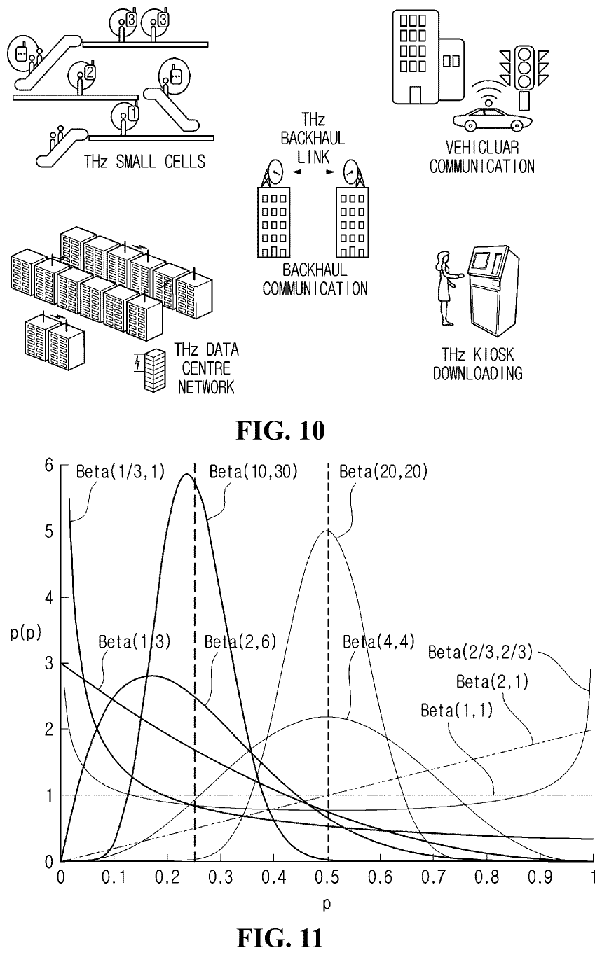

FIG. 10 illustrates a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### Multi-Arm Bandits (MAB) and Thompson Sampling (TS)

MAB means a system in an environment where a plurality of selectable candidates are present, enabling one candidate to be selected at a time and giving a different degree of reward in response to each selected candidate. Herein, a selectable candidate may be referred to as arm. Herein, the MAB problem is about finding a way of selection as an answer that maximizes the sum of rewards, when the number of opportunities to select is limited to N.

The MAB problem may be solved through exploration and exploitation. Exploitation is a way of selecting a best candidate based on the existing observation, and exploration is a way of selecting a new candidate to more observation results. If the cumulative explorations are too few, selection may be based on erroneous information, and on the other hand, if there are too many explorations, unnecessary opportunity cost may occur to acquire more information in spite of the presence of sufficient information. Thus, exploitation and exploration have a trade-off relationship, and the key to solving the MAB problem lies in optimizing the trade-off relationship.

As one approach to solving the MAB problem, Thompson sampling may be used. Thompson sampling uses a beta distribution to express a probability of a positive reward for selection of each arm. Herein, the beta distribution is a probability distribution model that is expressed by two parameters α and β. According to Thompson sampling, values are randomly sampled on an x axis for each beta distribution, and then a candidate corresponding to a largest value is identified. Thus, a candidate is selected. A value of reward according to selection of the candidate is used to update α and β that constitute the beta distribution of the candidate. For example, a positive result increases α by 1, and a negative result increases β by 1.

The beta distribution, which is used to express a probability distribution of each candidate in Thompson sampling, is defined as shown in Equation 1.

$$Beta ( x \vert α , β ) = \frac{1}{B ( α , β )} {{x}^{α - 1} ( 1 - x )}^{β - 1} \qquad [ Equation 1 ]$$

$$B ( α , β ) = {\int }_{0}^{1} {{x}^{α - 1} ( 1 - x )}^{β - 1} dx$$

Referring to Equation 1, the beta distribution is a continuous probability distribution that is defined by two parameters α and β in a range [0, 1]. The beta distribution may be visualized with a graph as shown in FIG. 11. FIG. 11 illustrates examples of probability density function of beta distribution applicable to the present disclosure. FIG. 11 exemplifies beta distributions with (α, β) of (⅓,1), (10,30), (20,20), (1,3), (2,6), (4,4), (⅔,⅔), (2,1) and (1,1). Referring to FIG. 11, as the value of α/(α+β) increases, the central location of a beta distribution becomes closer to 1, and as the value of β/(α+β) increases, the central location of a beta distribution becomes closer to 0. As the value of (α+β) increases, the width of a beta distribution becomes narrower, and all the values become closer to the center. In addition, as the value of (α+β) decreases, the values of a beta distribution are widely dispersed.

According to Thompson sampling, a reward distribution of each candidate is estimated by using existing data, and a candidate, which will give a highest reward, is selected according to the estimated distribution. Specifically, by random sampling based on a beta distribution, one candidate is selected probabilistically. Based on a result of an action performed according to the selected candidate, a or B of the selected candidate is updated. When the number of occasions of selecting the candidate increases, a corresponding beta distribution may be more concentrated around the central location. If the weight of a increases, a probability of being selected again increases, and if the weight of β increases, the probability of being selected again decreases. When the number of occasions of selecting a candidate is small, a beta distribution may change to a form that is dispersed widely, and a possibility of being selected later occurs.

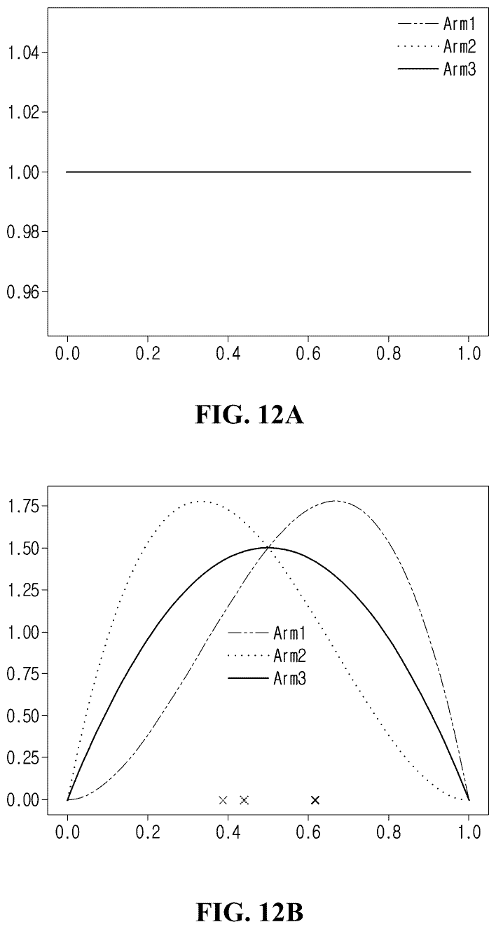

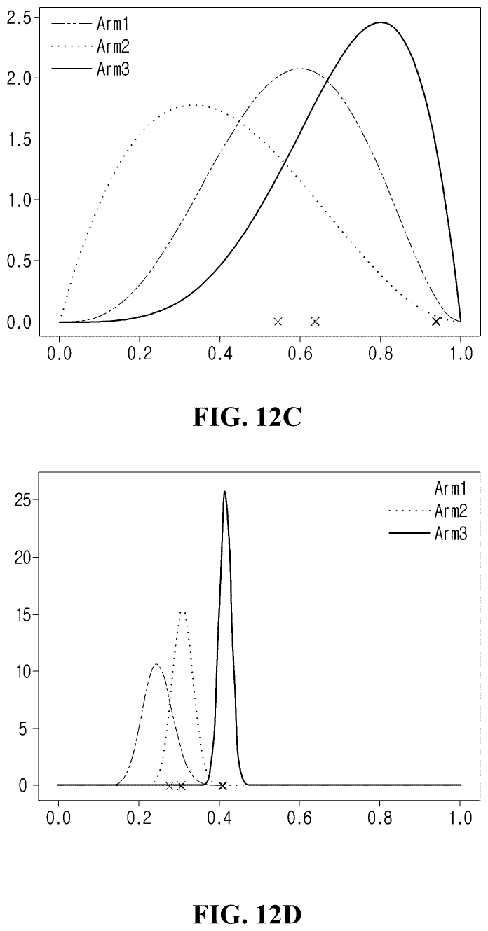

Update of beta distributions is specifically exemplified in FIG. 12A to FIG. 12D below. FIG. 12A to FIG. 12D illustrate an example of update of a probability distribution model applicable to the present disclosure. FIG. 12A to FIG. 12D exemplify changes of 3 beta distributions (e.g., Arm 1, Arm 2 and Arm 3), while selection is performed about 1,500 times.

Referring to FIG. 12A, Arm 1, Arm 2 and Arm 3 initially have the same (α, β), that is, (1, 1), (1, 1) and (1, 1). As (α, β) is (1, 1), the beta distributions have a uniform distribution with a same probability (e.g., 1) for every x value. As all the three arms have the identical probability distribution, exploration starts with the same probability.

Referring to FIG. 12B, after exploration is performed about 8 times, Arm 1, Arm 2 and Arm 3 have (3,2), (2,3) and (2,2) for (α, β). With update of beta distribution, a probability of selecting each arm is also updated. No significant difference among the arms is shown yet. For each of Arm 1, Arm 2 and Arm 3, one value is sampled from the x-axis based on a probability. In FIG. 12B, because a largest value is selected in the beta distribution of Arm 3, Arm 3 will be selected. Selection of a value is based on a corresponding beta distribution, and random sampling is performed in consideration of a probability. For example, in the case of the beta distribution (2, 2) of Arm 3, when random sampling is performed by considering the probability, 0.5 will be selected with a highest frequency because it has a highest probability, but a different value from 0.5 may be selected with a lower frequency. Specifically, in the case of the beta distribution (2, 2) of Arm 3, as the y-axis value of 0.5 is approximately 1.5 and the y-axis value of 0.2 is approximately 1, it may be understood that a frequency of selecting 0.5 through random sampling is about 1.5 times a frequency of selecting 0.2.

Referring to FIG. 12C, after selection is performed 13 times, Arm 1, Arm 2 and Arm 3 have (4,3), (2,3) and (5,2) for (α, β). In FIG. 12C, the probability of being selected tends to decrease in the order of Arm 3, Arm 1 and Arm 2. Herein, for each of Arm 1, Arm 2 and Arm 3, one value is sampled from the x-axis based on a probability, and a largest value is selected in the beta distribution of Arm 3. Thus, Arm 3 will be selected. Referring to FIG. 12D, after selection is performed 1496 times, Arm 1, Arm 2 and Arm 3 have (33,100), (100,223) and (436,611) for (α, β). As exploration has been sufficiently performed about 1,500 times, Arm 3 has an overwhelmingly high probability of being selected.

### Specific Embodiments of the Present Disclosure

The present disclosure relates to configuring parameters related to a discontinuous reception (DRX) operation in a wireless communication system and to a technology for controlling at least one parameter related to a DRX operation according to a traffic feature of a terminal. Specifically, the present disclosure proposes a technology for supporting an efficient DRX operation based on an AI by not increasing communication latency and signaling overhead and maximizing power saving effect in a period without data transmission of a terminal.

In the present disclosure, configuring, reconfiguring, adjusting, controlling or modifying parameters includes applying a specific value to a given parameter. For example, configuring an on-duration length, which is one of parameters related to a DRX operation, may be understood as applying a specific time length value as the on-duration length.

With drastic increase of frequency and data communication volume in cellular communication, communication power consumption of a terminal is gradually rising. A current communication system supports a DRX technique of reducing a control channel monitoring time in a data-free duration, and thus power consumption of a terminal is reduced. However, depending on the state and usage environment of a terminal, at least one parameter related to an optimal DRX operation (hereinafter, ‘DRX parameter’) may be different. When a base station monitors the state and usage environment of a terminal in real time and changes a DRX parameter in order to reflect the state and usage environment of the terminal, signal overhead and power consumption may be increased. Accordingly, the present disclosure proposes a technology of maximizing the power saving effect of a terminal by optimizing a DRX parameter adaptively according to the state and usage environment of the terminal, while preventing communication latency and signaling overhead from being increased.

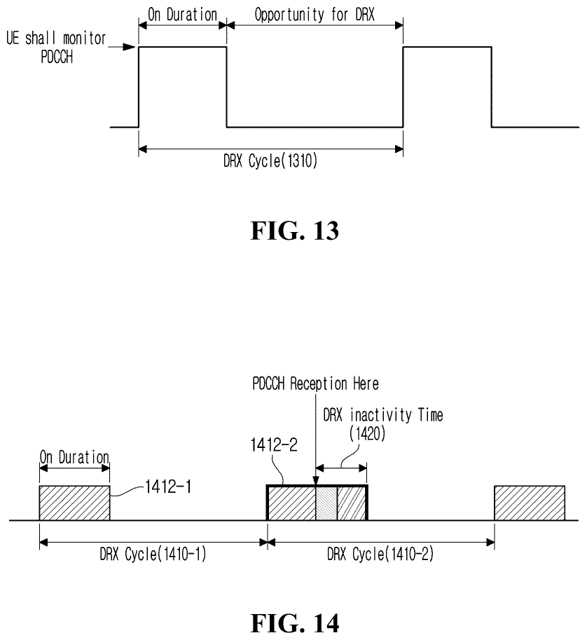

According to various embodiments, a DRX operation proceeds as follows. To receive data transmitted from a base station, a terminal continuously monitors a control signal. For example, the terminal monitors a paging signal in idle mode and monitors a PDCCH in connected mode. To reduce power consumption caused by control signal monitoring in a duration without data transmission, the terminal divides an entire reception period into an active state duration and a sleep state duration according to an order of the base station. The active state duration and the sleep state duration may be distinguished as shown in FIG. 13 and FIG. 14 below.

FIG. 13 illustrates an example of a cycle of a discontinuous reception (DRX) operation in a wireless communication system according to an embodiment of the present disclosure. Referring to FIG. 13, one DRX cycle 1310 includes a first duration, which is referred to as on-duration, and a second duration that is referred to as opportunity for DRX. Herein, the first duration may be understood as an active state duration, and the second duration may be understood as a sleep state duration. Herein, during the first duration, a UE may monitor a PDCCH. That is, the DRX cycle 1310 is a cycle of repeating the active state and the sleep state, the on-duration is an active state duration, and the remaining opportunity for DRX is a sleep state duration. In addition, the UE may perform control signal monitoring during the active state duration and may not perform the control signal monitoring during the remaining sleep state duration.

FIG. 14 illustrates an example of a situation in which data is received during a DRX operation in a wireless communication system according to an embodiment of the present disclosure. FIG. 14 exemplifies a DRX operation based on connected mode during 2 DRX cycles 1410-1 and 1410-2. Referring to FIG. 14, a PDCCH is not received in an on-duration 1412-1 of the first DRX cycle 1410-1. The PDCCH is received in an on-duration 1412-2 of the second DRX cycle 1410-2. When the PDCCH is decoded in the on-duration 1412-2, that is, in the active state duration, a data channel, that is, a PDSCH is received, while an inactivity time 1420 is activated. Until the inactivity timer 1420 expires, the duration for PDCCH monitoring is extended. Thus, when data is continuously transmitted, communication latency caused by a DRX operation may be reduced.

For a DRX operation shown in FIG. 13 and FIG. 14, relevant parameters need to be configured. A base station may configure on/off of a DRX operation and parameters related to the DRX operation by using a RRC connection setup procedure. In addition, a terminal (or UE) may request may transmit information related to a preferred DRX to the base station by using UE assistance information (UAI) and thus request to change a DRX parameter. Based on the UAI, the base station may change at least one DRX parameter by using a RRC reconfiguration procedure.

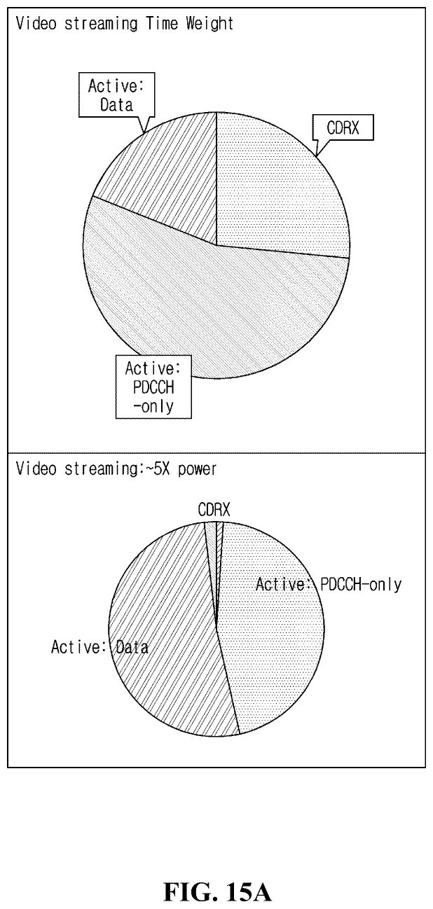

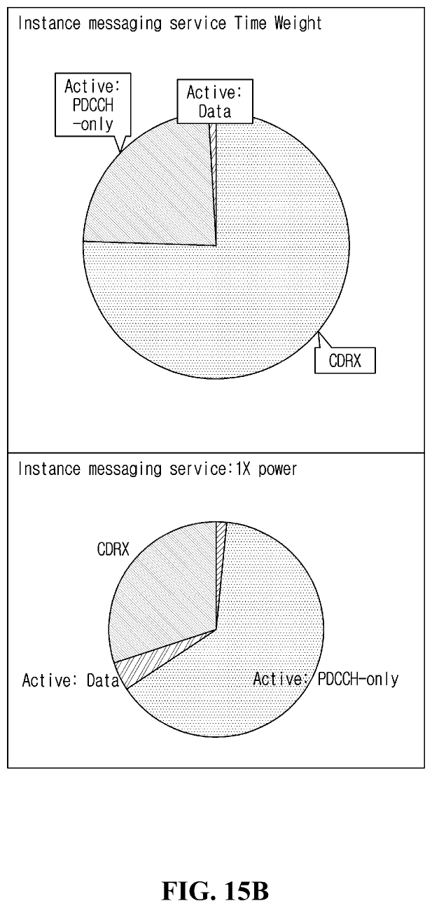

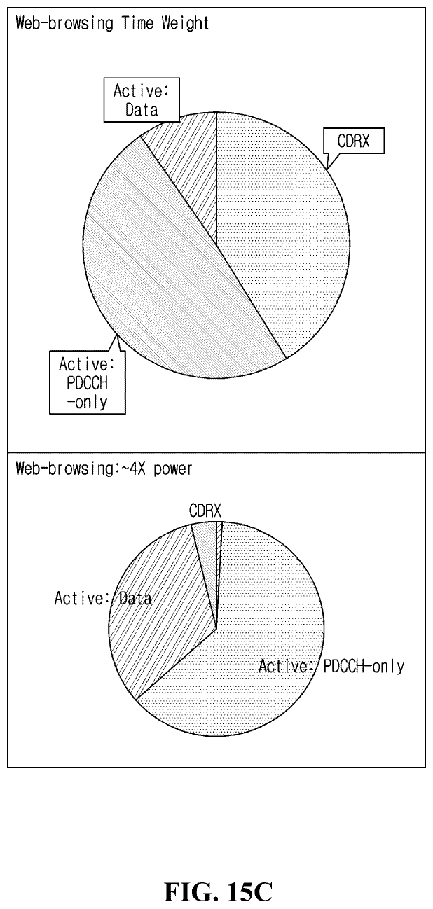

Depending on the state and usage environment of a terminal, an optimal DRX parameter may be different. FIG. 15A to FIG. 15C illustrate examples of power consumption distributions according to each situation in a wireless communication system according to an embodiment of the present disclosure. FIG. 15A to FIG. 15C show terminal power consumption for three typical use cases, that is, video streaming, message and web browsing. In FIG. 15A to FIG. 15C, the upper section exemplifies time distributions of UE states, and the lower section exemplifies power distributions. Herein, “active data” means a data reception state, “Active: PDCCH-only” means a state in which an inactivity timer is triggered after data reception and only a PDCCH is monitored before expiration, and “CDRX” means a DRX cycle during which there is no data reception and thus the inactivity timer is not triggered. Referring to FIG. 15A to FIG. 15C, as shown in the distribution chart, much power is consumed in the “Active: PDCCH-only state” of all the three cases, and the weight of the state is different in each of the use cases. Accordingly, by configuring an optimized DRX parameter for the state and usage environment of a terminal, under the condition that the quality of service (QoS) is maintained, it is desirable to minimize PDCCH monitoring in a data-free duration. However, if a DRX parameter is to be changed while a base station monitors every information in real time, signaling overhead and power consumption may increase. Accordingly, in order to overcome this limitation, the present disclosure proposes a technology of optimizing DRX parameters adaptively according to the state and usage environment of a terminal by using an AI algorithm.

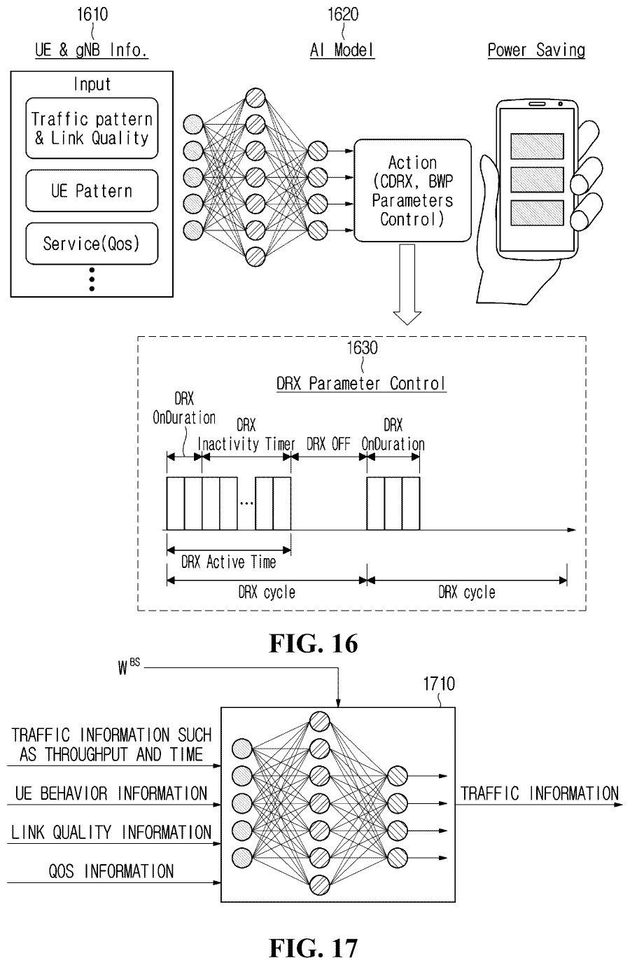

FIG. 16 illustrates a concept of control of parameters related to a DRX operation in a wireless communication system according to an embodiment of the present disclosure. Referring to FIG. 16, a DRX parameter control technology according to various embodiments may adaptively change a DRX parameter based on information 1610 related to a feature of a user situation/environment, traffic and packet delay and thus minimize an increment of average latency, while maximizing power saving gain for PDCCH monitoring. According to an embodiment, as a terminal operates an AI model 1620, the terminal may calculate an optimal DRX parameter, apply the DRX parameter and then deliver the DRX parameter to a base station, based on information such as the behavior, QoS, battery state and power consumption of the terminal and the information 1610 related to traffic and permissible parameter range as received from the base station. Control 1630 of a DRX parameter is performed by combining a traffic prediction and an AI-based DRX parameter prediction, and a DRX parameter optimized for the state and usage environment of a terminal may be configured. Herein, the AI model 1620 may have a structure as described in FIG. 17 below.

FIG. 17 illustrates an example of an artificial intelligence (AI) model for predicting a traffic feature in a wireless communication system according to an embodiment of the present disclosure. FIG. 17 is a means of traffic prediction, and the traffic prediction may be performed by using the behavior information and environmental information of a terminal based on an AI model. Referring to FIG. 17, an AI model 1710 may apply information on the environment and situation of a terminal and perform inference by using a weight that a network or a base station learns, thereby effectively predicting a traffic feature corresponding to the environment and the situation. Input data for a predictive algorithm may include various variables such as current traffic information of the terminal (e.g., throughput, packet arrival time), UE behavior information, link quality information and QoS information. The AI model 1710 may predict traffic or a traffic feature from input data through an optimal weight reflecting intra-cell environment in a network or base station. In the present disclosure, an AI model, which predicts a traffic feature as in FIG. 17, may be referred to as ‘traffic prediction model’.

Configuring, reconfiguring, adjusting, modifying or controlling of a DRX parameter according to various embodiments of the present disclosure is a technology of enabling an optimized DRX operation for an environment by combining a traffic prediction and a DRX parameter prediction. Herein, an AI-based DRX parameter prediction may be based on a selection algorithm based on Thompson sampling that ensures excellent performance as compared to other methods of solving the MAB problem.

The Thompson sampling is an algorithm that maintains QoS and enables a change to a DRX parameter with greatest power saving effect, when configuring a DRX parameter in a current state and a usage environment of a terminal. MAB is a technique of balancing exploitation and exploration in recommendation. Exploitation may recommend DRX parameters that maintain QoS and have greatest power saving effect, while exploration may recommend DRX parameters with high uncertainty to collect more information. By the MAB technique, new DRX parameters may be adequately recommended through exploration, and feedback on the recommended DRX parameters may be efficiently reflected in a terminal and every base station. The presence of trade-off between exploitation and exploration and the adjustment of exploitation and exploration may temporarily seem to be damage to a terminal, but a lot of DRX parameters are identified through exploration, which results in overall higher efficiency.

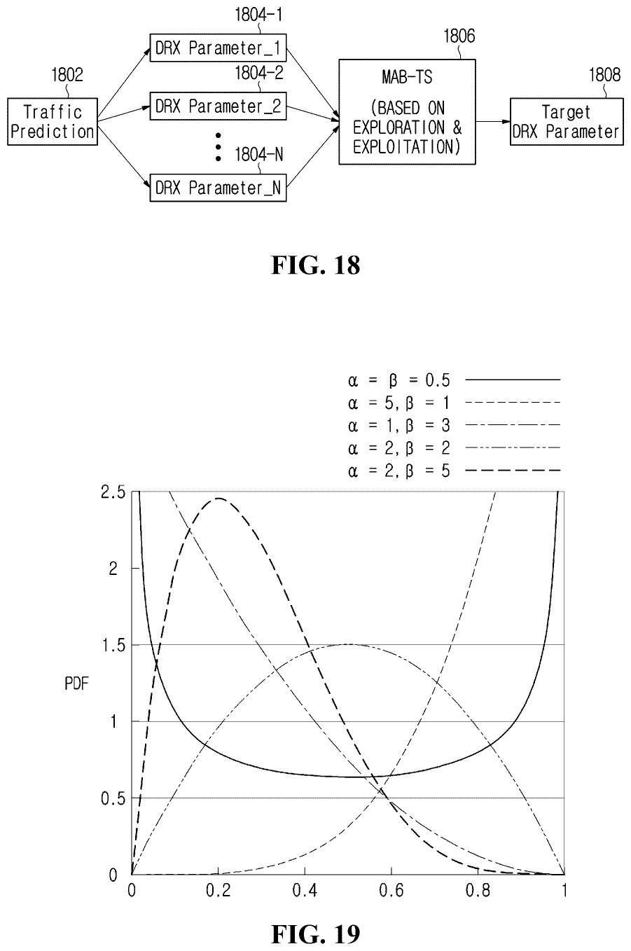

FIG. 18 illustrates a concept of parameter determination based on Thompson sampling (TS) in a wireless communication system according to an embodiment of the present disclosure. Referring to FIG. 18, based on a traffic prediction result 1802 of a terminal, a plurality of DRX parameters 1804-1 to 1804-N (e.g., a first value, a second value, . . . , an N-th value as time values for an inactivity timer) are identified. Among the plurality of DRX parameters 1804-1 to 1804-N, if an exploitation and exploration-based MAB-TS technique 1806 is applied, at least one target DRX parameter 1808 (e.g., an n-th value as a time value for the inactivity timer) may be selected. According to various embodiments, data used in the MAB-TS technique 1806 is a probability distribution for each of the DRX parameters 1804-1 to 1804-N.

As described above, a value of at least one DRX parameter may be determined by using Thompson sampling. Thompson sampling is an algorithm that estimates a reward distribution of candidate DRX parameter values, when configuring DRX parameters based on past observation data, and selects with high probability a candidate likely to give a highest reward based on the estimated distribution. In the most basic Bernoulli Thompson sampling, a reward given to each candidate has a value of 0 or 1 with a probability of p on account of Bernoulli trial, and the prior probability of p may follow a beta distribution. The beta distribution is a continuous probability distribution that is defined by two parameters α and β in a range [0, 1]. The beta distribution may be expressed with a graph as shown in FIG. 19 below.

FIG. 19 illustrates examples of probability density function of beta distribution available in a wireless communication system according to an embodiment of the present disclosure. FIG. 19 exemplifies beta distributions with (α, β) of (0.5,0.5), (5,1), (1,3), (2,2) and (2,5). Referring to FIG. 19, as the value of a/(α+β) increases, the central location of a beta distribution becomes closer to 1, and as the value of β/(α+β) increases, the central location of a beta distribution becomes closer to 0. For example, for a selected candidate, if a reward of 1 and a reward of 0 occur 5 times and 3 times respectively, a reward probability p of the candidate may be estimated to have a distribution of Beta (5, 3).

According to various embodiments, when Thompson sampling is applied to configuring a value of at least one DRX parameter, selectable values may correspond to beta distributions exemplified in FIG. 19. In this case, a value of a DRX parameter is selected by using probability matching based on given beta distributions, that is, estimated distributions, and this is a method of maximizing a probability of giving a positive reward to a value of a DRX parameter selected in a base station.

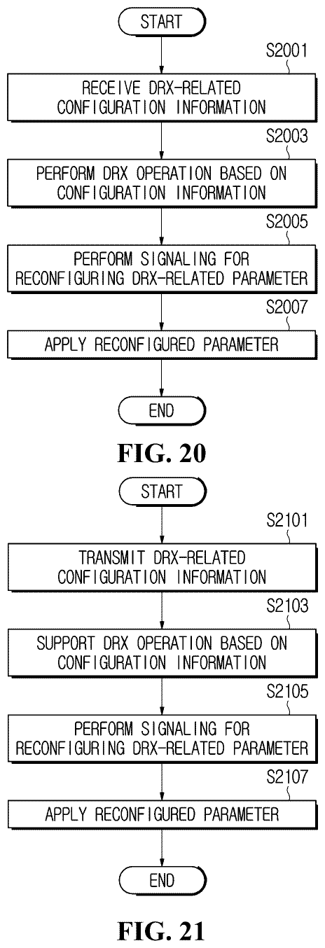

FIG. 20 illustrates an example of a procedure of performing a DRX operation in a wireless communication system according to an embodiment of the present disclosure. FIG. 20 exemplifies a method for operating a UE that performs a DRX operation.

Referring to FIG. 20, at step S2001, the UE receives DRX-related configuration information. The DRX-related configuration information includes values of parameters necessary for a DRX operation. For example, the DRX-related configuration information may include at least one of a length of each duration in a DRX cycle, a timer value related to a DRX operation, a DRX cycle length, and an HARQ parameter. In addition, the DRX-related configuration information may include information indicating an DRX operation. According to an embodiment, configuration information may further include information related to control for at least one DRX parameter. For example, the information related to control for at least one DRX parameter may include at least one of information regarding whether reconfiguration of a DRX parameter is permitted and information necessary for traffic prediction.

At step S2003, the UE performs a DRX operation based on the configuration information. The UE may configure DRX parameters based on the configuration information and operate an active state duration and a sleep state duration according to the configured DRX parameters. That is, the UE monitors a signal (e.g., PDCCH) only during the active state duration. When there is no data reception, the UE may enter the sleep state, and when data reception occurs, the UE may further perform monitoring during an inactivity timer.

At step S2005, the UE performs signaling for reconfiguring at least one DRX-related parameter. The UE may transmit or receive a message for reconfiguring at least one DRX parameter. According to an embodiment, the UE may transmit a first message indicating a traffic feature, receive a second message including information necessary for determining a value of at least one DRX parameter based on the traffic feature, and then transmit a third message indicating the determined value of the at least one DRX parameter. For example, the second message may include at least one of information related to a controllable parameter and information necessary to determine a parameter. Specifically, the second message may include at least one of a permissible range of DRX parameter reconfiguration, selectable candidate DRX parameter values, and probability distribution information for candidate DRX parameter values. Herein, the permissible range may include a quantitative range (e.g., at least one parameter item) and a temporal range.

At step S2007, the UE applies at least one reconfigured parameter. The UE may reconfigure at least one DRX parameter and operate an active state duration and a sleep state duration according to the at least one reconfigured DRX parameter. That is, the UE monitors a signal (e.g., PDCCH) only during the active state duration. When there is no data reception, the UE may enter the sleep state, and when data reception occurs, the UE may further perform monitoring during the inactivity timer.

FIG. 21 illustrates an example of a procedure of controlling a DRX operation in a wireless communication system according to an embodiment of the present disclosure. FIG. 21 exemplifies a method for operating a base station that controls a DRX operation.

Referring to FIG. 21, at step S2101, the UE transmits DRX-related configuration information. The DRX-related configuration information includes values of parameters necessary for a DRX operation. For example, the DRX-related configuration information may include at least one of a length of each duration in a DRX cycle, a timer value related to a DRX operation, a DRX cycle length, and an HARQ parameter. In addition, the DRX-related configuration information may include information indicating an DRX operation. According to an embodiment, configuration information may further include information related to control for at least one DRX parameter. For example, the information related to control for at least one DRX parameter may include at least one of information regarding whether reconfiguration of a DRX parameter is permitted and information necessary for traffic prediction.

At step S2103, the base station supports a DRX operation based on the configuration information. The base station may perform communication with the UE based on a DRX cycle that is configured according to the configuration information. For example, when data to be transmitted to the UE is generated, the base station transmits a signal to a signal (e.g., PDCCH) within an active state duration of the DRX cycle. Specifically, the base station may identify the DRX cycle and an on-duration based on the configuration information related to the DRX operation of the UE and transmit a control signal for data scheduling in the identified on-duration.

At step S2105, the base station performs signaling for reconfiguring a DRX-related parameter. The base station may receive or transmit a message for reconfiguring at least one DRX parameter. According to an embodiment, the base station may receive a first message indicating a traffic feature, transmit a second message including information necessary for determining a value of at least one DRX parameter based on the traffic feature, and then receive a third message indicating the determined value of the at least one DRX parameter. For example, the second message may include at least one of a permissible range of DRX parameter reconfiguration, selectable candidate DRX parameter values, and probability distribution information for candidate DRX parameter values. Herein, the permissible range may include a quantitative range (e.g., at least one parameter item) and a temporal range.

At step S2107, the base station applies at least one reconfigured parameter. The base station may perform communication with the UE based on the at least one reconfigured parameter. For example, when data to be transmitted to the UE is generated, the base station transmits a signal to a signal (e.g., PDCCH) within an active state duration of the DRX cycle. Specifically, the base station may identify the DRX cycle and an on-duration based on the at least one reconfigured parameter and transmit a control signal for data scheduling in the identified on-duration

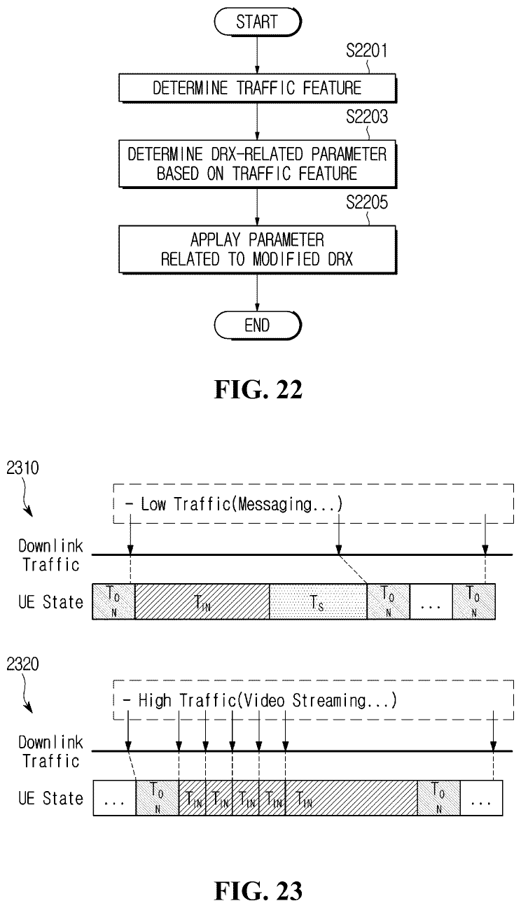

FIG. 22 illustrates an example of a procedure of determining a parameter related to a DRX operation in a wireless communication system according to an embodiment of the present disclosure. FIG. 22 exemplifies a method for operating a UE that performs a DRX operation.

Referring to FIG. 22, at step S2201, the determines a traffic feature. The UE may collect input data and determine the traffic feature based on the collected input data. For example, the input data may include at least one of throughput, packet arrival time, behavior of UE, linkage quality, and required QoS information. To this end, the UE may measure a channel, estimate a position or pose by using a sensor, analyze statistics of data reception according to each flow, or identify configured QoS information. According to an embodiment, the UE may determine the traffic feature from the input data by using an AI model such as a machine learning model or a deep learning model. According to another embodiment, the UE may determine the traffic feature from the input data by using a rule-based mapping table. Herein, the AI model or the rule-based mapping table may be defined in advance or configured by the base station. According to various embodiments, the use of an AI model may be understood as performing predictive computation by using the AI mode in the UE or providing the input data to a third device and then receiving output data generated by predictive computation of the third device.

At step S2203, the UE determines at least one DRX-related parameter based on the traffic feature. In other words, the UE determines a value of at least one DRX parameter that is optimized according to the traffic feature. According to an embodiment, the UE may determine the value of the DRX parameter based on probability distributions of candidate values. To this end, the UE may identify a set of probability distributions corresponding to the traffic feature selected at step S2201 and select one of the candidate values according to a Thompson sampling technique based on probability distributions in the identified set.

At step S2205, the UE applies at least one parameter related to modified DRX. To this end, the UE may perform signaling with the base station to modify a value of at least one DRX parameter. For example, the UE may transmit a message including the determined value to the base station.

In the embodiment described with reference to FIG. 22, a DRX parameter value to be applied by DRX parameter reconfiguration may be selected based on a Thompson sampling technique. In this case, although not illustrated in FIG. 22, the UE may provide the base station with information necessary for updating a probability distribution for the selected DRX parameter value. The information necessary for updating the probability distribution provides an indication regarding whether or not a gain occurs as a result of the selection of the DRX parameter result. Herein, the gain may include at least one of whether or not QoS is maintained and a power saving gain. Specifically, the information necessary for updating the probability distribution may include at least one of evaluation information for determining whether or not a gain occurs (e.g., an indicator regarding whether or not QoS is maintained, a power saving gain value), a reward value determined based on the evaluation information, and a probability distribution updated based on the reward value.

According to the various embodiments described above, DRX parameters may be adaptively configured according to a situation of a terminal. An example of adjustability of a DRX parameter according to a traffic feature is as shown in FIG. 23 below.

FIG. 23 illustrates examples of DRX operation according to a traffic feature in a wireless communication system according to an embodiment of the present disclosure. FIG. 23 exemplifies a first situation 2310 such as a messaging service with a low traffic feature and a second situation 2312 such as video streaming with a high traffic feature. In FIG. 23, TON means an on-duration, that is, an active state duration, TIN means a duration in which an inactivity timer is maintained, and Ts means a sleep state duration.

Like in the first situation 2310, in the case of a messaging service usage environment, traffic is relatively low, and a restriction on latency is also relatively low. Accordingly, the length of an inactivity timer may become relatively smaller. On the other hand, like in the second situation 2320, in the case of a usage environment like video streaming, traffic is relatively high, but a time interval between data packets is short and a predetermined size of data is buffered in advance, and thus it is possible to sufficiently reduce the length of the inactivity time likewise.

A procedure of configuring DRX parameters according to the above-described various embodiments may be a traffic prediction-based DRX configuration. To this end, a base station may hold beta distribution information of a Thompson sampling model for selectable candidate DRX parameter values for configuring a DRX parameter in every throughput and delay budget situation and provide the beta distribution information to a terminal. Herein, beta distribution information managed by the base station is determined based on reward information that is determined according to feedback from a terminal that selects a DRX parameter value. That is, the base station holds beta distribution information reflecting reward information that is determined according to whether or not a terminal selecting a DRX parameter value in every throughput and delay budget situation maintains QoS and a DRX power saving gain. According to various embodiments, a DRX parameter configuration procedure may be divided into 4 main phases.

In a first phase, after a terminal is connected to a cellular network, a base station transmits traffic prediction-related information to the terminal in order to perform adaptive DRX, and the terminal monitors a signal in a PDCCH-only duration, in which no data is transmitted and only a PDCCH is monitored, and performs traffic prediction. If a temporal distribution value of the PDCCH-only duration is equal to or greater than a predetermined value, a request for change of a DRX parameter and predicted traffic information (e.g., throughput and latency budget) are transmitted to the base station through UAI.

In a second phase, the base station transmits a RRC connection reconfiguration command including information necessary for predicting a DRX parameter to the terminal. For example, the information necessary for predicting a DRX parameter may include at least one of a permissible range of DRX parameter to be changed by the terminal, selectable candidate DRX parameters, and beta distribution information of a Thompson sampling model corresponding to a current state (e.g., throughput and latency budget) of the terminal.

In a third phase, the terminal performs DRX parameter prediction based on information (e.g., TS model beta distribution) reflecting a DRX parameter change history of every terminal. In addition, the terminal selects a DRX parameter value, which maintains QoS and has a highest DRX power saving gain (e.g., a maximum value among random sampled values of beta distributions of candidate DRX parameter values), and transmits the selected DRX parameter value to the base station. In addition, after a time set by the base station (e.g., a time included in the RRC connection reconfiguration command), the terminal changes a value of a corresponding parameter to the selected value.

In a fourth phase, after DRX parameter reconfiguration, whether or not QoS is maintained and a DRX power saving gain value are delivered to the base station through a RRC connection reconfiguration complete message. The base station may update a DRX parameter prediction model by using the information received from the terminal. Alternatively, the terminal may calculate information (e.g., a reward value) for updating the prediction model and transmit a calculation result to the base station. A criterion for determining a reward may be described as follows.

According to an embodiment, if QoS is adversely affected by increasing latency, a reward value is 0. If QoS is maintained, a reward may be determined based on energy efficiency of a DRX operation based on a new DRX parameter value, that is, based on a power saving gain, as shown in Equation 2 below. Specifically, a reward value may be determined to be 0 or 1 by comparing a distribution value of a PDCCH-only duration and a threshold (e.g., a PDCCH-only distribution value of a previous DRX parameter-a predetermined value).

$$R = \{ \begin{matrix}1 , & {PDCCHOP}_{T} < {PDCCHOP}_{S} - Δ \\ 0 , & {PDCCHOP}_{T} \geq {PDCCHOP}_{S} + Δ\end{matrix} \qquad [ Equation 2 ]$$

In Equation 2, R means a reward value, PDCCHPT means a PDCCH-only distribution of a DRX parameter after a DRX parameter change, PDCCHs means a PDCCH-only distribution of a DRX parameter before a DRX parameter change, and Δ means a margin value for determining a threshold. If the reward value is 1, a reward parameter α increases by 1, and if the reward value is 0, a reward parameter β increases by 1.

That is, while QOS is maintained, if a monitoring time reduction for a control channel in a data-free duration is equal to or greater than a predetermined value, a reward value is determined to be 1. On the other hand, while QoS is adversely affected or is maintained, if the monitoring time reduction for the control channel in the data-free duration is smaller than the predetermined value, the reward value is determined to be 0.

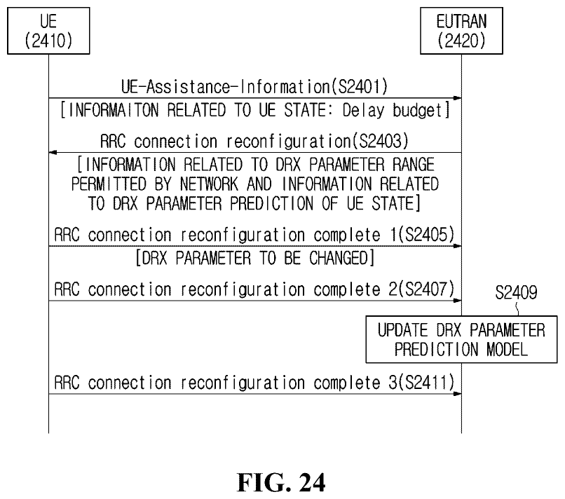

FIG. 24 illustrates an example of signal exchange for updating a parameter related to a DRX operation in a wireless communication system according to an embodiment of the present disclosure. FIG. 24 exemplifies signal exchange between a UE 2410 and an evolved UMTS terrestrial radio access network (EUTRAN) 2420. Herein, the EUTRAN 2420 may be understood as a base station.

Referring to FIG. 24, at step S2401, the UE 2410 transmits a UE assistance information (UAI) message to the EUTRAN 2420. The UAI message may include state information of the UE 2410 (e.g., at least one of a throughput and a latency budget). According to an embodiment, the UE 2410 may perform traffic prediction, and if a given condition is satisfied, transmit a UAI message including information indicating a traffic feature.

At step S2403, the EUTRAN 2420 transmits a RRC connection reconfiguration message to the UE 2410. The RRC connection reconfiguration message may include information related to a DRX parameter reconfiguration range permitted by a network and information related to DRX parameter prediction corresponding to a UE state. For example, the information related to DRX parameter prediction may include probability distribution information (e.g., beta distributions) of respective candidate parameter values for a Thompson sampling technique.

At step S2405, the UE 2410 transmits a first RRC connection reconfiguration complete message to the EUTRAN 2420. The first RRC connection reconfiguration complete message may include at least one of a DRX parameter to be changed and a value to be applied through change. That is, the UE 2410 performs DRX parameter prediction based on information received at step S2403 and transmits a DRX parameter value determined through the DRX parameter prediction to the EUTRAN 2420.

At step S2407, the UE 2410 transmits a second RRC connection reconfiguration complete message to the EUTRAN 2420. The second RRC connection reconfiguration complete message may include information for updating a model for DRX parameter prediction. For example, the information for updating the model for DRX parameter prediction may include a reward value or a performance-related value for determining a reward value.

At step S2409, the EUTRAN 2420 updates the DRX parameter prediction model. The EUTRAN 2420 identifies or determines a reward value based on information included in the second RRC connection reconfiguration complete message and updates a probability distribution of candidate parameter values based on the reward value. Herein, the updated probability distribution is a beta distribution corresponding to a candidate parameter value selected by the UE 2410.

At step S2411, the UE 2410 transmits a third RRC connection reconfiguration complete message to the EUTRAN 2420. Herein, the third RRC connection reconfiguration complete message may be transmitted to additionally reconfigure a DRX parameter. That is, the UE 2410 may update DRX parameters dynamically for a time permitted by the EUTRAN 2420. That is, once reconfiguration of a DRX parameter is permitted, the UE may repeatedly reconfigure the DRX parameter for a set time that is permitted. Herein, whether or not reconfiguration of a DRX parameter is permitted once may be identified by receiving the RRC connection reconfiguration message of step S2403.

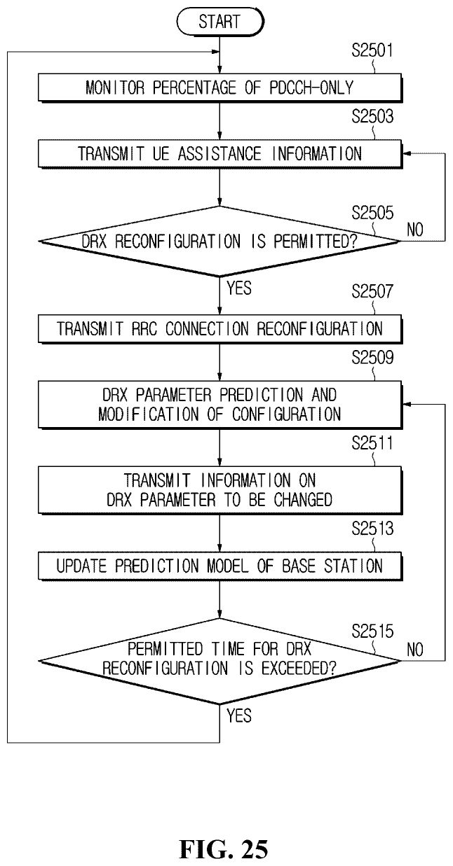

FIG. 25 illustrates an example of a procedure for updating a parameter related to a DRX operation in a wireless communication system according to an embodiment of the present disclosure. FIG. 25 exemplifies a method for operating a UE performing a DRX operation and a base station controlling the DRX operation.

Referring to FIG. 25, at step S2501, the UE monitors a percentage of a PDCCH-only duration. The UE identifies an occupancy rate of the PDCCH-only duration in an overall time duration where a DRX operation is performed. The PDCCH-only duration is a duration from the start of an inactivity timer with reception of DCI for the UE to the expiration of the inactivity timer. During the duration, PDCCH monitoring alone is performed. The PDCCH-only duration may be referred to as ‘data-free inactivity timer duration’ or another term with a technical meaning equivalent thereto.

At step S2503, the UE transmits UAI to the base station. The UAI is transmitted to request reconfiguration of a DRX parameter and may include information indicating a traffic feature of the UE. To this end, the UE may predict the traffic feature by using an AI model. For example, the traffic feature may be specified by at least one of a throughput and a latency budget.

At step S2505, the base station determines whether or not DRX parameter reconfiguration is permitted. Whether or not DRX reconfiguration is permitted may be determined based on at least one of a capability of the UE, a state of a model for DRX parameter prediction, and the traffic feature indicated by the UE.

If the DRX parameter reconfiguration is permitted, at step S2507, the base station transmits a RRC connection reconfiguration message to the UE. The RRC connection reconfiguration message notifies that the DRX parameter reconfiguration is permitted. In addition, the RRC connection reconfiguration message may include at least one of a range of a DRX parameter, for which reconfiguration is permitted, information related to a model for DRX parameter prediction, and a permitted time for DRX parameter reconfiguration.

At step S2509, the UE performs DRX parameter prediction and perform modification of configuration. Based on the information related to the model for DRX parameter prediction received at step S2507, the UE selects one of candidate parameter values. In addition, the UE modifies a DRX parameter by using the selected value.

At step S2511, the UE transmits information on a DRX parameter to be changed. That is, the UE may transmit a message including at least one of a DRX parameter to be changed (e.g., an inactivity timer) and a value to be changed (e.g., a timer value). Herein, the message may include a RRC connection reconfiguration complete message.

At step S2513, a prediction model of the base station is updated. Specifically, the base station updates at least one of probability distributions for DRX parameter prediction. To this end, the UE identifies performance information such as whether or not QoS is maintained after reconfiguration of a DRX parameter and a power saving gain and then transmits the performance information or a reward value determined based on the performance information to the base station. In addition, the base station determines or identifies the reward value and updates a probability distribution corresponding to a DRX parameter that is changed based on the reward value.

At step S2515, the UE determines whether or not a permitted time for DRX parameter reconfiguration is exceeded. The UE may further reconfigure the DRX parameter until the permitted time for DRX parameter reconfiguration expires. After the permitted time for DRX parameter reconfiguration expires, if the DRX parameter reconfiguration is needed, the UE returns to step S2501 and monitors the percentage of the PDCCH-only duration.

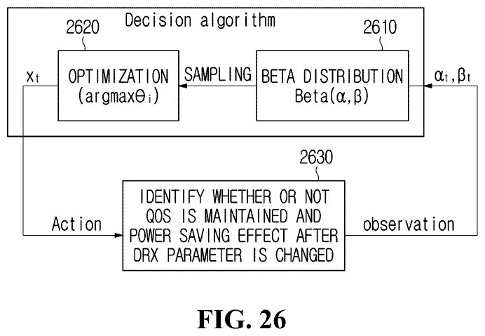

In the various embodiments described above, when a Thompson sampling model is used, efficiency of a DRX operation may be gradually improved with updates of probability distributions based on feedback. The update of a beta distribution according to a reward in a Thompson sampling model may be described as in FIG. 26 below. FIG. 26 illustrates a reward structure based on TS in a wireless communication system according to an embodiment of the present disclosure.

FIG. 26 shows a structure in which feedback on a reward is given based on an evaluation indicator after completion of handover (e.g., whether or not QoS is maintained, a power saving gain, etc.). Referring to FIG. 26, sampling includes an operation of sampling values randomly in the beta distribution 2110 of candidate cells. A maximum value among the sampled values is selected by the optimization 2120. An action means selecting a DRX parameter value by which QoS is maintained in a current state and usage environment and the power saving effect is highest. Observation includes an operation of updating parameters of a beta distribution for reward based on the evaluation 2130 for identifying whether QoS is maintained after DRX parameter reconfiguration and a power saving effect. The updated parameters are reflected in the beta distribution 2210.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

### INDUSTRIAL APPLICABILITY

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method comprising:
receiving configuration information related to a discontinuous reception (DRX) operation from a base station;
performing the DRX operation based on the configuration information;
transmitting a first message including information related to at least one parameter related to the DRX operation; and
receiving a second message including information related to reconfiguration for the at least one parameter,
wherein the first message includes information related to a traffic feature that is determined by a user equipment (UE) and is used to reconfigure the at least one parameter.

2. The method of claim 1, wherein the second message includes at least one of a permitted range of reconfiguration of parameters related to the DRX operation, selectable candidate parameter values, and probability distribution information for-related to the candidate parameter values.

3. The method of claim 1, further comprising:
transmitting a third message including a parameter value that is determined by the UE and is to be applied by the reconfiguration.

4. The method of claim 1, further comprising:
determining the traffic feature by using an artificial intelligence (AI) model,
wherein the AI model has, as input data, at least one of a throughput, a packet arrival time, a behavior of the UE, linkage quality, and required quality of service (QoS) information.

5. The method of claim 1, further comprising:
identifying respective probability distributions for each candidate parameter values corresponding to the traffic feature based on the second message; and
selecting one parameter value of the candidate parameter values based on the probability distributions.

6. The method of claim 5, wherein the one parameter value is selected based on Thompson sampling.

7. The method of claim 5, further comprising:
identifying at least one of whether quality of service (QOS) is maintained after the selected parameter value is applied or a power saving gain according to a DRX operation; and
transmitting information related to updating a probability distribution corresponding to the selected parameter value based on whether the QoS is maintained or the power saving gain according to the DRX operation.

8. The method of claim 7, wherein the information related to updating the probability distribution includes at least one of evaluation information including at least one of an indicator regarding whether the QoS is maintained or a power saving gain value, a reward value determined based on the evaluation information, or a probability distribution that is updated based on the reward value.

9. The method of claim 1, further comprising:
identifying a permitted time for the reconfiguration of the at least one parameter related to the DRX operation indicated by the second message; and
transmitting, before the permitted time expires, a fourth message including a parameter value that is determined by the UE and is to be applied by the reconfiguration.

10-16. (canceled)

17. A user equipment (UE) comprising:
a transceiver; and
a processor coupled with the transceiver,
wherein the processor is configured to:
receive configuration information related to a discontinuous reception (DRX) operation from a base station,
perform the DRX operation based on the configuration information,
transmit a first message including information related to at least one parameter related to the DRX operation, and
receive a second message including information related to reconfiguration for the at least one parameter, and
wherein the first message includes information related to a traffic feature that is determined by the UE and is used to reconfigure the at least one parameter.

18. A base station comprising:
a transceiver; and
a processor coupled with the transceiver,
wherein the processor is configured to:
transmit configuration information related to a discontinuous reception (DRX) operation to a user equipment (UE),
control the DRX operation based on the configuration information,
receive a first message including information related to at least one parameter related to the DRX operation, and
transmit a second message including information related to reconfiguration for the at least one parameter, and
wherein the first message includes information related to a traffic feature that is determined by the UE and is used to reconfigure the at least one parameter.

19-20. (canceled)

21. The base station of claim 18, wherein the second message includes at least one of a permitted range of reconfiguration of parameters related to the DRX operation, selectable candidate parameter values, and probability distribution information related to the candidate parameter values.

22. The base station of claim 18, wherein the processor is further configured to:
receiving a third message including a parameter value that is determined by the UE and is to be applied by the reconfiguration.

23. The base station of claim 22, wherein the parameter value is selected based on Thompson sampling.

24. The base station of claim 22, wherein the processor is further configured to:
receiving information related to updating a probability distribution corresponding to the parameter value.

25. The base station of claim 24, wherein the information related to updating the probability distribution includes at least one of evaluation information including at least one of an indicator regarding whether quality of service (QoS) is maintained or a power saving gain value after the parameter value is applied, a reward value determined based on the evaluation information, or a probability distribution that is updated based on the reward value.

26. The base station of claim 25, wherein the reward value is determined based on whether a ratio of a data-free inactivity timer duration to an overall time duration with a DRX operation being formed exceeds a threshold, and
wherein the data-free inactivity timer duration is a duration from start of an inactivity timer to expiration of the inactivity timer and includes a duration during which only monitoring of a control channel is performed.
